(19) United States
(12) Patent Application Publication
(10) Pub. No.: US 2019/0174952 A1
(43) Pub. Date: Jun. 13, 2019

(54) FOOD COOKING METHOD

(71) Applicant: SEB S.A., ECULLY (FR)

(72) Inventors: Philippe BOURRIANNE, PARIS (FR); Laurent CAILLIER, PRINGY (FR); David QUERE, PARIS (FR); Céline HOFLEITNER, ANNECY (FR)

(21) Appl. No.: 16/071,763

(22) PCT Filed: Jan. 19, 2017
(86) PCT No.: PCT/FR2017/050114

§ 371 Date: Jul. 20, 2018

(30) Foreign Application Priority Data
Jan. 21, 2016 (FR) 1650496

(51) Int. Cl. A47J 36/02; B05D 5/08

(52) U.S. Cl. CPC A47J 36/025; B05D 5/08

(57) ABSTRACT

A method for cooking a food including free water, uses a cooking vessel having at least one cooking surface, the cooking surface being such that a drop of distilled water can form a contact angle with the cooking surface that is greater than or equal to 150° at ambient temperature, and the food being such that its water activity a_{w} is greater than or equal to 0.5. The method includes heating the cooking surface to a minimum temperature of 125° C.; placing the food on the cooking surface; and cooking the food on the cooking surface.

This invention concerns a food cooking method, and in particular a method for cooking a food on a superhydrophobic surface.

People have always sought to improve the taste of raw food. This has mainly resulted in the recommendation and use of cooking methods that can make foods more digestible and in particular more colorful and delicious.

In the “pan-fried” cooking method, the food is placed on a hot cooking surface to quickly cook the food's outer layer, forming a crust on its surface. This cooking method not only permits creating flavors, thanks in part to the Maillard reaction, but also retaining as much as possible of the moisture and nutrients inside the food. Pan-frying is often accompanied by the use of a cooking aid such as cooking oil.

In addition to control of crust formation and coloration, there is an interest today, in the context of healthier cooking, in limiting the use of oil as much as possible and avoiding the phenomena of carbonization due to preferential adherent contacts between the cooking surface and the food.

To solve these problems, those skilled in the art know of the method of using non-stick coatings, such as polytetrafluoroethylene-based coatings (PTFE) or metal alkoxide-based coatings (known as ceramic coatings and obtained through a sol-gel process). In spite of their remarkable non-stick performances, and while they generally permit cooking without oil, these systems do not completely avoid the phenomena of food adhesion to the surface. An illustration of this assertion is the lack of mobility of a food in the process of being cooked on such surfaces (for example, a fried egg).

The Leidenfrost phenomenon is known and has been described in particular in the doctoral thesis of Anne-Laure HIMBERT BIANCE in 2005 (Université de Paris VI—“Gouttes inertielles: de la caléfaction à l'étalement”).

When a drop of liquid is placed on a very hot surface, the liquid deposited takes several minutes to evaporate and does not boil, although the temperature of the hot surface is much higher than the boiling point of the liquid. The drop of liquid deposited has very rounded edges and does not adhere to the surface; in addition, the drop is extremely mobile and moves away very easily. The temperature of the liquid during the Leidenfrost state (measured by plunging the tip of a thermocouple into the drop) is equal to the boiling point of said liquid.

In the Leidenfrost phenomenon, the liquid deposited levitates over the surface thanks to the formation of a vapor film that is interposed between the liquid deposited and the hot surface. The adhesive strength is considered to be nil because a perfect state of non-contact exists. The liquid and the vapor are also considered to be in equilibrium at the boiling point of the liquid. This equilibrium exists as long as the liquid offsets the vapor losses. Therefore, throughout the duration of this phenomenon, the temperature of the liquid is independent of the surface temperature.

The Leidenfrost phenomenon is well known on hydrophilic surfaces such as metals (Quéré et al., Physics of Fluids, 2003, 15, 6). In addition, for stainless steel and cooking applications, persons skilled in the art know of the “water drop test” as a cooking start temperature indicator. In the case of hydrophilic surfaces, the Leidenfrost state appears at temperatures higher than 250° C. and is made very unstable by the slightest chemical or physical defect of the surface. In fact, because the latter is intrinsically wetting, we shift immediately from a non-contact state to a contact state. In the case of a food that transforms with temperature, this inexorably leads to adhesion and the non-reversibility of the phenomenon. In addition, while high temperatures favor the formation of the vapor film, they also increase the phenomena of escape, of evacuation of this same vapor, from the film to the environment, and thus reduce the life span of the Leidenfrost liquid.

The applicant proposes to solve all or some of the aforementioned problems from the prior art and proposes a method for cooking a food containing free water by means of a cooking vessel having at least one cooking surface, said cooking surface being such that a drop of distilled water is able to present a contact angle with said cooking surface greater than or equal to 150° at ambient temperature, the food being such that its water activity a_{w} is greater than or equal to 0.5, the method comprising the following steps:
heating the cooking surface to a minimum temperature of 125° C.;
placing the food on the cooking surface; and
cooking the food on the cooking surface.

In the context of this invention, the temperatures mentioned, whether they are in particular the Leidenfrost temperatures or the boiling points, are indicated in reference to the use of the cooking method at ambient pressure, or about 1 atmosphere.

It has been discovered that the Leidenfrost phenomenon may exist at lower temperatures than the generally accepted temperatures for hydrophilic surfaces such as metals, and hydrophobic surfaces such as PTFE-based coatings. For example, a Leidenfrost phenomenon may be observed when a vapor film has been generated by heating a surface to a minimum temperature of 125° C. and then lowering the temperature to values of 100° C. for a surface with a contact angle with water greater than or equal to 150° at ambient temperature.

Advantageously, the life spans at the minimum Leidenfrost temperature of Leidenfrost water drops, on surfaces with a contact angle with water greater than or equal to 150° at ambient temperature, are longer in comparison to hydrophilic surfaces and hydrophobic surfaces, favored in this by less significant heat transfer than at high temperature. In addition, this Leidenfrost state is compatible with the temperatures of culinary articles generally used for cooking food (from 100 to 250° C.). Finally, in the event of surface defect, because the surface is intrinsically non-wetting, reversibility from a low contact state to a non-contact state is favored.

The cooking method according to this invention is particularly advantageous for cooking without adding fat. It permits obtaining the following properties:
the cooking surface is perfectly non-stick and easy to clean,
the temperature of the food surface in contact with the vapor film is constantly kept at the temperature of the vapor film, about 100° C. according to the conditions of implementation of the method, and preferably at 100° C. as long as the food contains water and thus there is potential for steam cooking, which is less drying and preserves nutrients,
delay in the appearance of coloration in the food,
reduction or even elimination of the formation of neoformed compounds,
control of the spread of the food on the cooking surface.

In this application, the term “cooking surface” is used in reference to the surface on which the food to be cooked is placed. For example, in the case of hollow cooking vessels like a saucepan or frying pan, the cooking surface is a portion of the vessel's inner surface, preferably having a size greater than or equal to 12 cm².

In this application, the expression “free water” signifies the share of free water in a food (and not the total water content of this food), that is, the available water that can create a vapor film during the cooking process by the Leidenfrost effect according to the invention.

In the application, the expression “water activity (a_{w})” signifies the measurement of free water in a food; a_{w} is generally between 0.5 and 1. The higher the parameter a_{w}, the more free water is available in the food. A water activity of a_{w}=1 corresponds to water.

Preferably, the cooking method according to the invention uses a food having a water activity a_{w} between 0.5 and 1, preferably between 0.8 and 1, more preferably between 0.9 and 1 and even more preferably between 0.95 and 1.

Within the meaning of the invention, the expression “distilled water” refers to a water that contains H₂O molecules, dissolved gases like O₂ and CO₂, and this water is free of certain mineral salts and organisms which are generally found in natural water. This distilled water may be obtained amongst others through non-successive or successive distillations. It is sometimes called pure water or purified water.

At ambient temperature, the pH of distilled water is generally about 5.4.

The cooking method according to the invention comprises at least 3 steps: the heating step, the placement step and the cooking step.

During the step of heating the cooking surface, the cooking surface may be heated advantageously to a temperature of between 125° C. and 250° C., preferably between 125° C. and 230° C., more preferably between 125° C. and 200° C. and even more preferably between 125° C. and 180° C.

The food may be placed on the cooking surface after, before or during the step of heating the cooking surface, depending on the food being cooked and the desired manner of cooking said food.

Placing the food on the cooking surface after the step of heating said cooking surface advantageously permits quickly establishing the Leidenfrost state (by rapidly bringing the water contained in the food up to the Leidenfrost temperature) and thus having the best potential for the food not to stick to the cooking surface.

In another embodiment, the food may be placed on the cooking surface before or during the step of heating said cooking surface, which produces benefits for the cooking of the food by starting to cook cold or at a low temperature and continuing the cooking at a temperature greater than or equal to 125° C. These benefits may, for example, allow the food to be heated before the desired transformation (denaturation of proteins, evaporation of free water). This applies more particularly to food reheating, or to gentle cooking where water loss from the food is to be minimized.

During the cooking of the food, the cooking surface may have a temperature equal to 125° C. but this temperature may be lowered during cooking to 100° C. or increased to over 125° C. without interrupting the Leidenfrost phenomenon, which advantageously permits holding the food in a Leidenfrost state. In addition, the higher the temperature of the cooking surface, the thicker the vapor film formed, again improving the non-stick performances of the invention method.

During the cooking step, the cooking surface temperature may vary advantageously between 100° C. and 250° C., preferably between 125° C. and 230° C., more preferably between 125° C. and 200° C. and even more preferably between 125° C. and 180° C.

During the cooking of the food according to the method of the invention, the food temperature is less than or equal to the boiling point of water, about 100° C. according to the conditions of implementation of the method, and preferably less than or equal to 100° C. It should be noted that a food's temperature may be in the form of a temperature gradient inside the food, the highest temperature being the one in contact with the vapor film.

During the cooking of the food, the cooking surface may have a minimum temperature of 125° C., preferably maintained at 125° C. Advantageously, this permits holding the food in a Leidenfrost state while preserving the food's organoleptic properties and significantly avoiding coloration of the food.

It may be advantageous to keep the cooking surface at a constant temperature while the food is being cooked. According to embodiment variants, this temperature may vary by ±2° C.

It may also be advantageous for the cooking surface temperature to have a non-constant profile while the food is being cooked. The cooking surface temperature may, for example, be increased or decreased while the food is being cooked. The cooking surface temperature may also have one or more increase phases and/or one or more decrease phases and/or one or more constant phases while the food is being cooked.

In the context of this invention, a “superhydrophobic surface” is a surface with a contact angle with a drop of distilled water greater than or equal to 150° at ambient temperature, preferably between 150° and 180° at ambient temperature, more preferably between 155° and 175° at ambient temperature, even more preferably between 165° and 170° at ambient temperature.

Within the meaning of this invention, a surface is considered to be hydrophilic when the static contact angle of a drop of distilled water placed on the surface is less than or equal to 90 degrees; it is considered to be hydrophobic when the static contact angle of a drop of distilled water placed on the surface is between 90 and 150° (the limits 90° and 150° are excluded from this range); and the surface is considered to be superhydrophobic when the static contact angle of a drop of distilled water placed on the surface is greater than or equal to 150 degrees.

In the context of this invention, a contact angle with the distilled water on a surface is measured by measuring the angle between the tangent to the drop of distilled water at the point of contact and the surface.

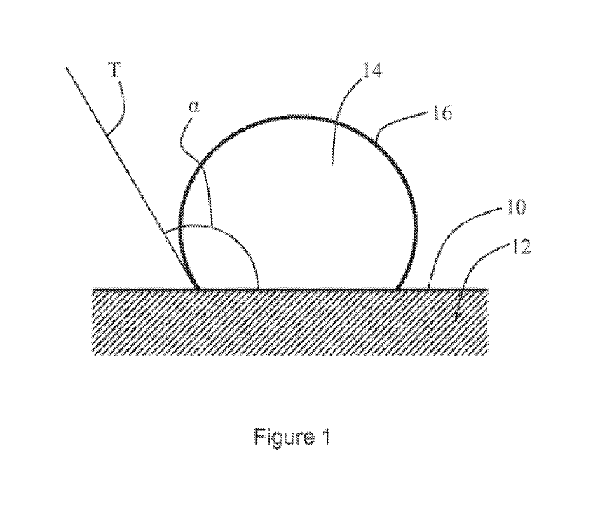

FIG. 1 illustrates the principle of measurement of a contact angle between a drop of distilled water and a cooking surface.

Advantageously, the cooking surface may be such that a drop of distilled water is able to present a contact angle with said cooking surface greater than or equal to 155° at ambient temperature, and preferably a contact angle with said cooking surface greater than or equal to 170° at ambient temperature. The use of the method according to the invention with superhydrophobic surfaces permits putting the food in a Leidenfrost state at a lower temperature than with hydrophobic surfaces, which permits having less water loss and better preservation of the food and its organoleptic properties.

The Leidenfrost temperature of water on a hot surface is evaluated by measuring, for different temperatures, the tilt angle of the surface permitting the mobility of a drop of water (tilt angle also being known as angle of inclination and directly related to the adhesive strength). When the tilt angle is equal to 0° and the drop is mobile, the adhesion is equal to 0 and thus the drop is in a Leidenfrost state. The Leidenfrost temperature is known with a precision of +/−10° C.

The cooking surface of the cooking vessel may be produced using different techniques which are described extensively in the literature and therefore known to the person skilled in the art (chemical attack, structuring by nano-embossing, laser, electroplating of polymers, partial decomposition, lithography, etc.) In one embodiment of this invention, water may be added while the food is being cooked. This increases the life span of the Leidenfrost phenomenon by offsetting the phenomena of water escaping to the environment in the form of steam. Water may be added, for example, by deglazing the cooking surface.

The cooking vessel used in the method of this invention may be chosen from the group comprising saucepans and frying pans, woks and skillets, Dutch ovens and kettles, crepe pans, gridirons, grates and barbecue grills.

According to one embodiment of this invention, the cooking method may be used to cook a fried egg. Cooking a raw egg on a bed of steam, that is, with the cooking surface in a Leidenfrost state, makes the egg white more uniform in appearance and taste by avoiding hot spots. In addition, cooking the raw egg in a Leidenfrost state on a superhydrophobic surface is done at a temperature between 125° C. and 180° C., which is perfectly suitable for obtaining the desired texture and color which are produced after denaturation of proteins (this denaturation takes place at temperatures of between 60 and 100° C., 60° C. for ovotransferrin and between 84.4 and 92.5° C. for ovalbumin). Cooking eggs at too high a temperature results in significant drying, which yields an unsatisfactory result (dry, rubbery).

### EXAMPLES

Tests

Measurement of Contact Angles

The hydrophobic nature of the surfaces used in the examples is evaluated by measuring the contact angle of a drop of water on the coating using a Krüss brand DSA100 goniometer.

FIG. 1 illustrates the principle of measurement of a contact angle between a cooking surface 10 of a cooking vessel 12 and a drop of distilled water 14 placed on the surface 10. The reference 16 designates the liquid/gas interface between the drop 14 and the ambient air. FIG. 1 is a cross section according to a plane perpendicular to the surface 10. In the section plane, the contact angle α corresponds to the angle, measured from the inside of the water drop 14, between the surface 10 and the tangent T to the interface 16 at the point of intersection between the solid 10 and the interface 16.

To measure the contact angle, the vessel 12 is placed in a room at the temperature of 20° C. and a relative humidity of 50%. A drop of distilled water 14 having a volume of 2.5 μL is placed on the surface 10 of the vessel 12. The angle α is measured by using an optical process, for example, by using a drop shape analysis device, such as the DSA100 device marketed by the company Kruss. The measurements are repeated five times and the value of the contact angle measured between the water drop and the cooking surface is equal to the average of these five measurements.

Measurement of Leidenfrost Temperatures

The Leidenfrost temperature of water on a hot surface is evaluated by measuring, for different temperatures, the tilt angle of the surface permitting the mobility of a drop of water (tilt angle also being known as angle of inclination and directly related to the adhesive strength). When the tilt angle is equal to 0° and the drop is mobile, the adhesion is equal to 0 and thus the drop is in a Leidenfrost state. The Leidenfrost temperature is known with a precision of +/−10° C.

Measurement of Water Activity

The water activity is measured using an electric hygrometer type of a_{w}-meter, which operates by measuring the resistance of a hygroscopic salt or by changing the capacitance of a capacitor comprising a hygroscopic polymer.

The water activity is determined by the following formula:

a_{w}=p/po=ERH(%)/100

where
p=Pressure of the water vapor in the food
po=Pressure of the pure water vapor
ERH=Mean relative humidity

Production of Tested Surfaces and Physicochemical Properties

The tests are performed in articles of identical shapes having a stainless steel substrate.
For certain tests, the article's cooking surface is left bare (surface 1), as is the case for a hydrophilic surface with a contact angle with the cooking surface equal to 70°
For other tests, a surface of the article is coated with a PTFE-based coating of a total thickness of 35 microns (surface 2), as is the case for a hydrophobic surface with a contact angle with the cooking surface equal to 110°:
For yet other tests, a surface of the article is coated with a “glaco” layer, that is, a layer based on hydrophobic silica colloid dispersed in an isopropyl alcohol, applied by means of spraying and provided by the company Soft 99; the “glaco” layer has a total thickness of 100 nanometers (surface 3) (the case for a superhydrophobic surface with a contact angle with the cooking surface equal to 175°);

The physicochemical properties of the prepared surfaces are summarized in the table below:

| | | | | Leidenfrost |
|---|---|---|---|---|
| | | | Contact | temperature of a |
| Surface | | | angle with | drop of distilled |
| number | Substrate | Coating | water (°) | water (° C.) |
| 1 | stainless steel | — | 70 | 250 ± 10 |
| 2 | stainless steel | PTFE | 110 | 240 ± 10 |
| 3 | stainless steel | glaco | 175 | 130 ± 10 |

Egg White Cooking Tests

For each test, 20 grams of raw egg whites are used. Cooking is done without fat. The water activity of this egg white is 0.99 for a pH of 7.8.

Cooking is stopped when the top of the egg white is smooth and coagulated and the culinary results are evaluated for each test. The adhesion and mobility of the egg are visually characterized by tilting the article at a slight tilt angle of less than 10°.

The culinary results are summarized in the table below:

| | Cooking | | Non-stick | |
|---|---|---|---|---|
| Surface | temperature | Mobility of | property after | |
| number | (° C.) | the egg white | cooking | Appearance of the white |
| 1 | 260 | no | The white has stuck | The white is cooked |
| | | | to the surface | nonhomogeneously, large burst |
| | | | | bubbles are observed which give |
| | | | | its upper surface a very rough |
| | | | | appearance. |
| | | | | The edges of the white are thin |
| | | | | and dried. |
| | | | | The bottom of the white is very |
| | | | | browned. |
| 2 | 250 | no | The white has stuck | The white is cooked |
| | | | to the surface | nonhomogeneously, large burst |
| | | | | bubbles are observed which give |
| | | | | its upper surface a very rough |
| | | | | appearance. |
| | | | | The edges of the white are thin |
| | | | | and dried. |
| | | | | The bottom of the white is very |
| | | | | browned. |
| 3 | 140° C. | The egg slides | No adhesion to the | The white is cooked very |
| | | spontaneously | surface | uniformly; it is still very supple. |
| | | from one edge | | The edges are still high around |
| | | of the article to | | the entire periphery. |
| | | the other | | The lower surface is white. |
| 3 | 180° C. | The egg slides | No adhesion to the | The white is cooked very |
| | | spontaneously | surface | uniformly; it is still very supple. |
| | | from one edge | | The edges are still high around |
| | | of the article to | | the entire periphery. |
| | | the other | | The lower surface is lightly |
| | | | | colored. |

The egg whites were cooked according to the method of the invention with surface number 3. The Leidenfrost state was established for this cooking with this surface number 3 and the results are satisfactory as indicated in the table above.

Whitefish Cooking Test (Cod)

For each test, 20 grams of cod are used. Cooking is done without fat. The water activity of this cod is 0.99.

The cooking is stopped when the top of the cod has turned completely opaque, and no longer translucent. The culinary results are evaluated for each test. The adhesion and mobility of the cod are visually characterized by tilting the article at a slight tilt angle of less than 10°.

| | Cooking | | Non-stick | |
|---|---|---|---|---|
| Surface | temperature | Mobility in | property after | Appearance of the food and |
| number | (° C.) | cooking | cooking | condition of cooking surface |
| 2 | 180 | no | Cod sticks slightly | Food is not colored. Residue in |
| | | | | the frying pan |
| 2 | 250 | no | Cod sticks slightly | Food has a light crust. |
| | | | | Residue in the frying pan |
| 3 | 180 | yes | No adhesion to the | Food is not colored. No residue in |
| | | | surface | the frying pan |
| 3 | 230 | yes | No adhesion to the | Food is not colored. No residue in |
| | | | surface | the frying pan |

The cod was cooked according to the method of the invention with surface number 3. The Leidenfrost state was established for this cooking with this surface number 3 and the results are satisfactory as indicated in the table above.

Scallops Cooking Test

For each test, 20 grams of scallops are used. Cooking is done without fat. The water activity of these scallops is 0.99.

The cooking is stopped when the top of the scallop has turned completely opaque, and no longer translucent. The culinary results are evaluated for each test. The adhesion and mobility of the scallop are visually characterized by tilting the article at a slight tilt angle of less than 10°.

| | Cooking | | Non-stick | |
|---|---|---|---|---|
| Surface | temperature | Mobility in | property after | Appearance of the food and |
| number | (° C.) | cooking | cooking | condition of cooking surface |
| 2 | 200 | no | adhesion of the | Food is colored |
| | | | scallop | Residue in the frying pan |
| 2 | 250 | no | adhesion of the | Food is colored |
| | | | scallop | Residue in the frying pan |
| 3 | 200 | yes | No adhesion to the | Food is lightly colored |
| | | | surface | No residue in the frying pan |
| 3 | 230 | yes | No adhesion to the | Food is lightly colored |
| | | | surface | No residue in the frying pan |

The scallops were cooked according to the method of the invention with surface number 3. The Leidenfrost state was established for this cooking with this surface number 3 and the results are satisfactory as indicated in the table above.

1. A method for cooking a food containing free water by means of a cooking vessel having at least one cooking surface, the cooking surface being such that a drop of distilled water is able to present a contact angle with the cooking surface greater than or equal to 150° at ambient temperature, the food being such that its water activity a_{w} is greater than or equal to 0.5, the method comprising:
heating the cooking surface to a minimum temperature of 125° C.;
placing the food on the cooking surface; and
cooking the food on the cooking surface.

2. The cooking method according to claim 1, wherein the water activity a_{w} of the food is between 0.8 and 1.

3. The cooking method according to claim 1, wherein the food is placed on the cooking surface after the heating of the cooking surface.

4. The cooking method according to claim 1, wherein the food is placed on the cooking surface before the heating of the cooking surface.

5. The cooking method according to claim 1, wherein the food is placed on the cooking surface during the heating of the cooking surface.

6. The cooking method according to claim 1, wherein, while the food is being cooked, the temperature of the food is less than or equal to the boiling point of water.

7. The cooking method according to claim 1, wherein the cooking surface is kept at a constant temperature while the food is being cooked.

8. The cooking method according to claim 1, wherein the temperature of the cooking surface is increased while the food is being cooked.

9. The cooking method according to claim 1, wherein the temperature of the cooking surface is decreased while the food is being cooked.

10. The cooking method according to claim 1, wherein the cooking surface is such that a drop of distilled water is able to present a contact angle with said cooking surface greater than or equal to 170° at ambient temperature.

11. The cooking method according to claim 1, wherein the cooking surface is heated to a temperature of between 125° C. and 250° C.

12. The cooking method according to claim 11, wherein the cooking surface is heated to a temperature of between 125° C. and 230° C.

13. The cooking method according to claim 1, wherein water is added while the food is being cooked.

14. The cooking method according to claim 1, wherein the cooking vessel is selected from the group consisting of saucepans and frying pans, woks and skillets, Dutch ovens and kettles, crepe pans, gridirons, grates and barbecue grills.
